(19) United States
(12) Patent Application Publication
(10) Pub. No.: US 2012/0140193 A1
(43) Pub. Date: Jun. 7, 2012

(54) DYNAMIC WAFER ALIGNMENT METHOD IN EXPOSURE SCANNER SYSTEM

(75) Inventors: Chui-Fu Chiu, Taoyuan County (TW); Chiang-Lin Shih, Taoyuan County (TW)

(73) Assignee: NANYA TECHNOLOGY CORPORATION, Taoyuan (TW)

(21) Appl. No.: 12/960,319

(22) Filed: Dec. 3, 2010

(51) Int. Cl. G03B 27/42

(52) U.S. Cl. 355/53; 355/77

(57) ABSTRACT

A dynamic wafer alignment method and an exposure scanner system are provided. The exposure scanner system having a scan path, includes an exposure apparatus, an optical sensor apparatus and a wafer stage. The method comprises the steps of: (a) providing a wafer, having a plurality of shot areas, wherein each shot area has a plurality of alignment marks thereon; (b) forming a photo-resist layer on the wafer; (c) detecting the alignment marks at a portion of a shot area along the scan path by the optical sensor apparatus to obtain compensation data for wafer alignment of the portion of the shot area; (d) performing real time feedback of the compensation data for wafer alignment to the wafer stage; (e) exposing the photo-resist layer at the portion of the shot area along the scan path; (f) continuously repeating the steps (c) to (e) at the shot area along the scan path until all of the photo-resist layer at the shot area are exposed; and (g) repeating the step (f) until the photo-resist layer of all of the shot areas on the wafer are exposed.

### BACKGROUND OF THE INVENTION

1. Field of the Invention

The present invention relates to a wafer alignment method, and in particular relates to a dynamic wafer alignment method in an exposure scanner system.

2. Description of the Related Art

During the semiconductor fabrication process, many exposure process steps require a wafer to be aligned in a certain orientation, such that an overlap accuracy of the patterns of each layer on the wafer can be achieved. The wafer used in the exposure process is generally provided with alignment marks thereon to indicate reference orientation positions of the patterns of a certain layer on the wafer.

A wafer has a plurality of shot areas, wherein one shot area is defined by an exposure region on the wafer with a photo mask through an exposure process. An exposure equipment typically performs the exposure process by irradiating light on a photo-resist layer overlying the wafer. The exposure equipment includes an exposure head, an alignment mark sensor, an alignment stage and an exposure stage. In a conventional wafer alignment method, one alignment mark is disposed on every few shot areas of the wafer. The alignment mark sensor detects the orientation positions of the alignment marks of the whole wafer at the alignment stage to obtain average compensation data for wafer alignment and the average compensation data for wafer alignment is conveyed to the exposure stage. Then, the photo resist layer of all shot areas on the wafer are exposed by the exposure head at the exposure stage according to the feedback of the average compensation data for wafer alignment to the exposure stage.

Recently, as the feature sizes of semiconductor devices have become smaller for new generation electronic products, the design rule of the semiconductor devices have shrunk. Accordingly, it is difficult to enlarge the process window of the semiconductor devices, especially for wafer alignment accuracy in an exposure equipment during an exposure process and overlay accuracy of the patterns of each layer on the wafer. Compensation data for wafer alignment of the shot areas in an area of a wafer is different from compensation data for wafer alignment of the shot areas in another area of the wafer. However, in the conventional wafer alignment method, the photo-resist layer of all shot areas on the wafer are exposed according to the average compensation data for wafer alignment. Thus, the conventional wafer alignment method cannot satisfy the high wafer alignment accuracy requirement for the semiconductor devices with smaller feature sizes.

Therefore, an improved wafer alignment method in an exposure equipment which can overcome the above problems to achieve high wafer alignment accuracy is desired.

### BRIEF SUMMARY OF THE INVENTION

According to an embodiment, a dynamic wafer alignment method in an exposure scanner system is provided, wherein the exposure scanner system having a scan path, includes an exposure apparatus, an optical sensor apparatus and a wafer stage. The method comprises the steps of: (a) providing a wafer, having a plurality of shot areas, wherein each shot area has a plurality of alignment marks thereon; (b) forming a photo-resist layer on the wafer; (c) detecting the alignment marks at a portion of a shot area along the scan path by the optical sensor apparatus to obtain compensation data for wafer alignment of the portion of the shot area; (d) performing real time feedback of the compensation data for wafer alignment of the portion of the shot area to the wafer stage; (e) exposing the photo-resist layer at the portion of the shot area along the scan path by the exposure apparatus after the real time feedback of the compensation data for wafer alignment of the portion of the shot area to the wafer stage; (f) continuously repeating the steps (c) to (e) at the shot area along the scan path until all of the photo-resist layer at the shot area are exposed; and (g) repeating the step (f) until the photo-resist layer of all of the shot areas on the wafer are exposed.

According to another embodiment, an exposure scanner system for a dynamic wafer alignment is provided. The exposure scanner system comprises an exposure apparatus. An optical sensor apparatus, having a plurality of alignment mark sensors, is disposed on the exposure apparatus. A single wafer stage is disposed under the exposure apparatus. In the exposure scanner system, the optical sensor apparatus detects a plurality of alignment marks on a wafer to obtain compensation data for the dynamic wafer alignment and performs real time feedback of the compensation data for the dynamic wafer alignment to the single wafer stage, and the exposure apparatus exposes a photo-resist layer on the wafer after the real time feedback of the compensation data for the dynamic wafer alignment to the single wafer stage

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a schematic view of an exposure scanner system according to an embodiment of the invention;

FIG. 2 shows a plane view of a wafer with a plurality of shot areas;

FIG. 3 shows a plane view of an alignment mark layout in a single shot area according to an embodiment of the invention; and

FIG. 4 is a flow chart of a dynamic wafer alignment method in an exposure scanner system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

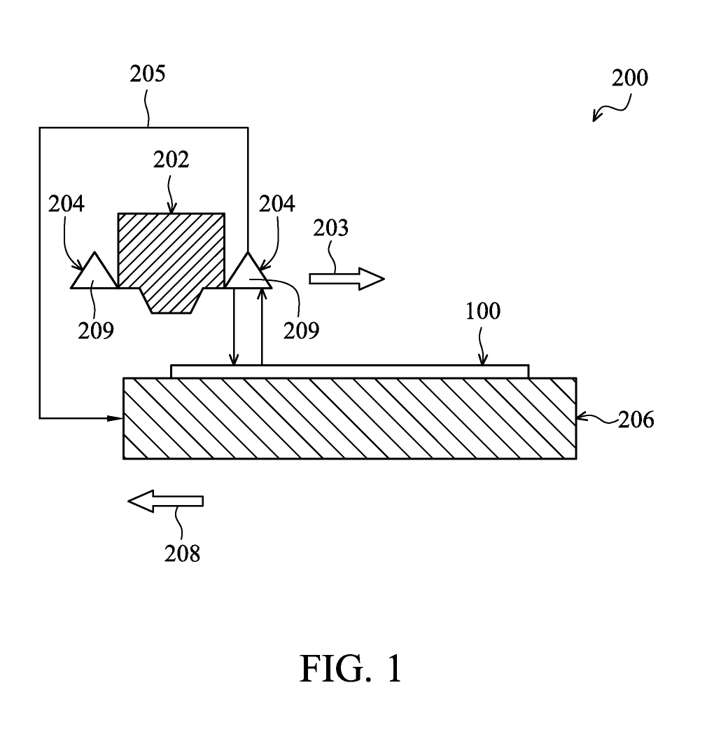

FIG. 1 is a schematic side view of an exposure scanner system 200 according to an embodiment of the invention. The exposure scanner system 200 includes an exposure apparatus 202, an optical sensor apparatus 204 including a plurality of alignment mark sensors 209, disposed on two opposite sides of the exposure apparatus 202, and a single wafer stage 206 disposed under the exposure apparatus 202. In the exposure scanner system 200, the exposure apparatus 202 and the optical sensor apparatus 204 have the same scan path 203. The wafer stage 206 has a movement path 208 opposite to the scan path 203. A wafer 100 having a photo-resist layer (not shown) formed thereon is provided on the wafer stage 206. The wafer 100 has a plurality of alignment marks (not shown) formed thereon. The alignment mark sensors 209 of the optical sensor apparatus 204 are disposed according to the positions of alignment marks on the wafer 100 for detecting the orientation information of the alignment marks. The alignment mark sensors 209 of the optical sensor apparatus 204 disposed on the two sides of the exposure apparatus 202 are used for performing an up direction scan and a down direction scan, respectively, or performing a left direction scan and a right direction scan, respectively. The alignment mark sensor 209 of the optical sensor apparatus 204 has a detection area which can cover the positions of alignment marks shifting from the position of the alignment mark sensors 209. In addition, the optical sensor apparatus 204 further comprises a signal processor (not shown) for processing the orientation information of the alignment marks to obtain compensation data 205 for wafer alignment. Then, a real time feedback of the compensation data 205 for wafer alignment to the wafer stage 206 is performed. The wafer stage 206 is typically provided with a wafer moving mechanism which can bring and rotate the wafer 100 to a center position in both an X and Y direction and tilt the wafer 100 to a certain angle in a Z direction according to a signal of the compensation data 205 for wafer alignment conveyed from the optical sensor apparatus 204. Such wafer moving mechanism is well known in the art and the details of the wafer moving mechanism are not discussed here.

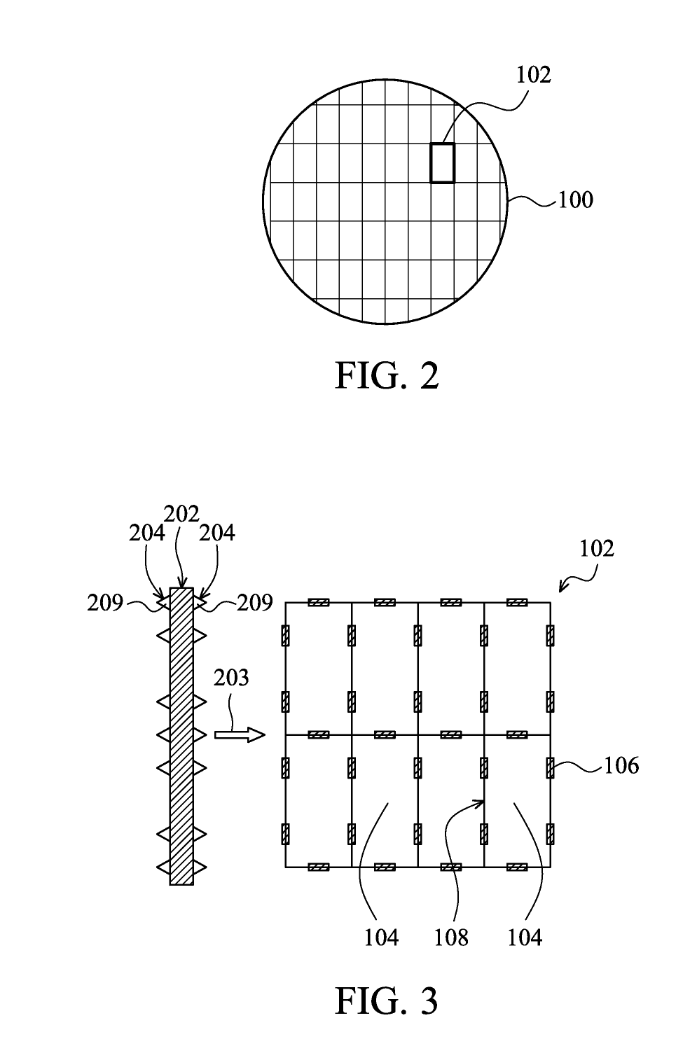

The exposure apparatus 202 generally comprises a UV light source to expose the photo-resist layer on the wafer 100 with a pattern of a photo mask. The exposure apparatus 202 continuously performs an exposure process on the photo-resist layer of one shot area along the scan path 203 after the wafer stage 206 receives the real time feedback of the compensation data 205 for wafer alignment and performs wafer alignment. Referring to FIG. 2, a plane view of a wafer 100 with a plurality of shot areas 102 is shown. One shot area 102 is defined by an exposure region on the wafer 100 exposed by a photo mask, and the photo mask generally comprises patterns for a plurality of chips. The photo-resist layer of one shot area is exposed with the photo mask by the exposure apparatus 202 along a scan path 203 until the photo-resist layer on the one shot area is completely exposed. Then, the photo-resist layer of next shot area is exposed with the photo mask by the exposure apparatus 202 along another scan path opposite to the scan path 203 until the photo-resist layer of all of the shot areas on the wafer 100 are exposed. The wafer 100 has shot areas 102 arranged by several columns and several rows as shown in FIG. 2.

Next, referring to FIG. 3, a plane view of a single shot area 102 on the wafer 100 according to an embodiment of the invention is shown. The single shot area 102 can correspond to a plurality of chips 104, for example 6 chips, 8 chips or 12 chips. The single shot area 102 as shown in FIG. 3 is an 8-chip shot area. In an embodiment of the invention, the single shot area 102 has a plurality of alignment marks 106 thereon. The alignment marks 106 are formed on a scribe line 108. The scribe line 108 is disposed between any two adjacent chips 104. Several or all of the alignment marks 106 at a portion of a single shot area 102 are detected by the alignment mark sensors 209 of the optical sensor apparatus 204 along the scan path 203 to obtain compensation data 205 for wafer alignment of the portion of the single shot area 102. As shown in FIG. 3, the locations of the alignment mark sensors 209 of the optical sensor apparatus 204 are disposed corresponding to the positions of the alignment marks 106. The compensation data 205 is related to the orientation and tilt information for wafer alignment of the portion of the single shot area 102. A real time feedback of the compensation data 205 of the portion of the single shot area 102 to the wafer stage 206 is performed and then the photo-resist layer of the portion of the single shot area 102 is immediately exposed. In the exposure scanner system 200, detecting the alignment marks 106, performing real time feedback of the compensation data 205 for wafer alignment to the wafer stage 206, and exposing the photo-resist layer are performed simultaneously and continuously in one shot area 102. While detecting the alignment marks at one portion of a shot area along the scan path is performed, the photo-resist layer at another portion adjacent to the one portion of the shot area is exposed along the scan path. In other words, pre-alignment of one portion of the shot area 102 is performed during exposing the photo-resist layer of another portion adjacent to the one portion of the shot area 102. In addition, detecting the alignment marks 106 and exposing the photo-resist layer are simultaneously performed in one shot area 102 at the single wafer stage 206.

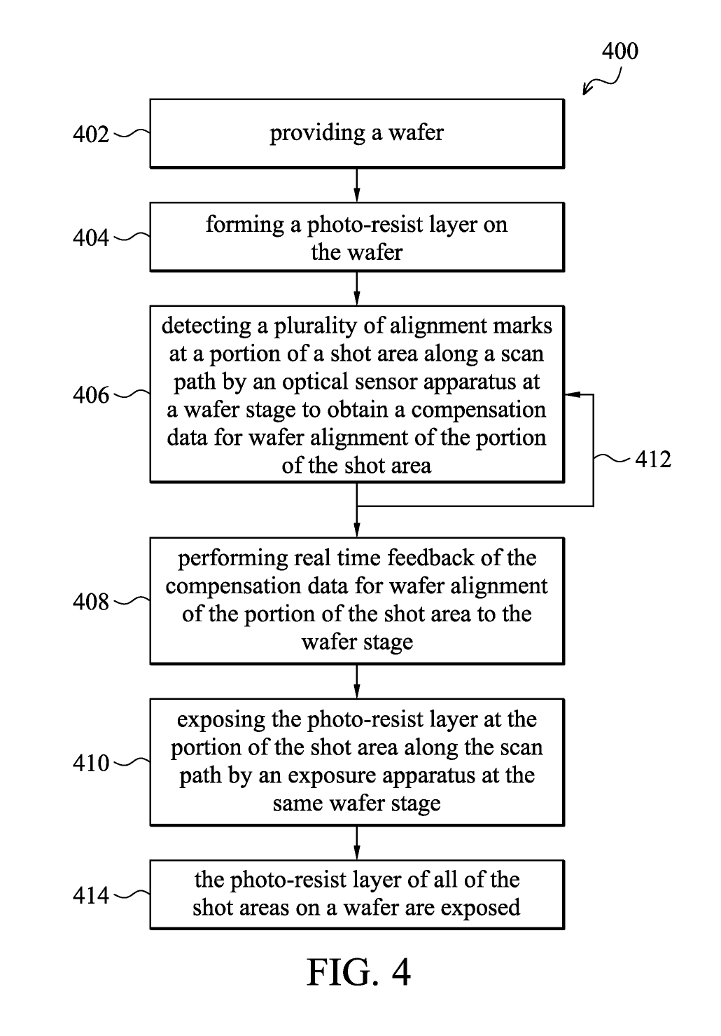

FIG. 4 illustrates a flow chart 400 of a dynamic wafer alignment method in an exposure scanner system according to an embodiment of the invention. The dynamic wafer alignment method can be performed in the exposure scanner system 200 as shown in FIG. 1. At step 402, a wafer 100 is provided. The wafer 100 has a plurality of shot areas 102 as shown in FIG. 2. Each shot area 102 has a plurality of chips 104 and has a plurality of alignment marks 106 formed on the scribe lines 108, as shown in FIG. 3. At step 404, a photo-resist layer is formed on the wafer 100, for example by a spin coating method.

At step 406, more than one alignment marks 106 at a portion of the single shot area 102 are detected by the alignment mark sensors 209 of the optical sensor apparatus 204 along the scan path 203 as shown in FIG. 3 to obtain compensation data for wafer alignment of the portion of the single shot area 102. The compensation data comprises wafer shift compensation data, wafer rotation compensation data, wafer tilt compensation data or combinations thereof. In an embodiment, some of the alignment marks 106 in the single shot area 102 are sampled to be detected by the alignment mark sensors 209 of the optical sensor apparatus 204. In another embodiment, all of the alignment marks 106 in the single shot area 102 are detected by the alignment mark sensors 209 of the optical sensor apparatus 204 to obtain more complete compensation data for wafer alignment.

Then, at step 408, real time feedback of the compensation data for wafer alignment of the portion of the shot area 102 to the wafer stage 206 is performed. Meanwhile, step 412 is performed for continuously detecting more than one alignment marks 106 at another portion of the single shot area 102 adjacent to the portion of the single shot area 102 which has been scanned by the optical sensor apparatus 204.

At step 410, an exposure process for the photo-resist layer at the portion of the shot area 102 is immediately performed at the same wafer stage 206 by the exposure apparatus 202 along the scan path 203 after the real time feedback of the compensation data for wafer alignment of the portion of the shot area 102 to the wafer stage 206. The steps 406, 408 and 410 are continuously repeated in sequence at one shot area along the scan path 203 until the photo-resist layer at the one shot area is completely exposed. Moreover, the steps 406, 408 and 410 are simultaneously performed in one shot area 102.

At step 414, the steps 406, 408, 410, and 412 for one shot area 102 end until the photo-resist layer of all of the shot areas 102 on the wafer 100 are exposed.

As the feature sizes of semiconductor devices become increasingly small and the sizes of the wafers continue to grow for new generation electronic products, compensation data for wafer alignment of shot areas at different positions at the wafer are different. However, the conventional wafer alignment method in an exposure scanner system is performed by exposing the photo-resist layer of all shot areas on the wafer with average compensation data for wafer alignment. Thus, the conventional wafer alignment method cannot satisfy the requirement of wafer alignment accuracy for the semiconductor devices with smaller feature sizes.

According to an embodiment of the dynamic wafer alignment method in the exposure scanner system, the photo-resist layer of a shot area on the wafer is exposed according to real time feedback of the compensation data for wafer alignment of the shot area to the wafer stage. Since the photo-resist layer of the shot area is exposed with real time feedback of the compensation data for wafer alignment of the shot area itself to the wafer stage, the wafer alignment accuracy of all of the shot areas on the wafer in the exposure process according to the embodiment of the dynamic wafer alignment method of the invention is enhanced. Furthermore, according to the embodiment of the dynamic wafer alignment method of the invention, the wafer alignment accuracy deviation issue for a wafer to a wafer in a lot and for wafers of a lot to a lot during mass production is overcome.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dynamic wafer alignment method in an exposure scanner system, wherein the exposure scanner system having a scan path, includes an exposure apparatus, an optical sensor apparatus, and a wafer stage, the method comprising the steps of:
(a) providing a wafer, having a plurality of shot areas, wherein each shot area has a plurality of alignment marks thereon;
(b) forming a photo-resist layer on the wafer;
(c) detecting the alignment marks at a portion of a shot area along the scan path by the optical sensor apparatus to obtain compensation data for wafer alignment of the portion of the shot area;
(d) performing real time feedback of the compensation data for wafer alignment of the portion of the shot area to the wafer stage;
(e) exposing the photo-resist layer at the portion of the shot area along the scan path by the exposure apparatus after the real time feedback of the compensation data for wafer alignment of the portion of the shot area to the wafer stage;
(f) continuously repeating the steps (c) to (e) at the shot area along the scan path until all of the photo-resist layer at the shot area are exposed; and
(g) repeating the step (f) until the photo-resist layer of all of the shot areas on the wafer are exposed.

2. The method as claimed in claim 1, wherein detecting the alignment marks, performing real time feedback of the compensation data for wafer alignment to the wafer stage, and exposing the photo-resist layer are performed simultaneously in the shot area.

3. The method as claimed in claim 2, wherein detecting the alignment marks at one portion of a shot area along the scan path is performed during exposing the photo-resist layer at another portion adjacent to the one portion of the shot area along the scan path.

4. The method as claimed in claim 1, wherein the optical sensor apparatus has a plurality of alignment mark sensors.

5. The method as claimed in claim 4, wherein the alignment mark sensors are disposed according to positions of the alignment marks.

6. The method as claimed in claim 1, wherein detecting the alignment marks for wafer alignment and exposing the photo-resist layer are performed at the same wafer stage.

7. The method as claimed in claim 1, wherein each shot area comprises a plurality of chips and a scribe line is disposed between any two adjacent chips, wherein the alignment marks are disposed on the scribe line.

8. The method as claimed in claim 1, wherein the compensation data for wafer alignment comprises wafer shift compensation data, wafer rotation compensation data, wafer tilt compensation data or combinations thereof.

9. The method as claimed in claim 1, wherein the compensation data for wafer alignment of each shot area is different.

10. The method as claimed in claim 1, wherein the exposure apparatus and the optical sensor apparatus have the same scan path for one shot area.

11. An exposure scanner system for a dynamic wafer alignment, comprising:
an exposure apparatus;
an optical sensor apparatus, having a plurality of alignment mark sensors, disposed on the exposure apparatus; and
a single wafer stage disposed under the exposure apparatus,
wherein the optical sensor apparatus detects a plurality of alignment marks on a wafer to obtain compensation data for the dynamic wafer alignment and performs real time feedback of the compensation data for the dynamic wafer alignment to the single wafer stage, and the exposure apparatus exposes a photo-resist layer on the wafer after the real time feedback of the compensation data for the dynamic wafer alignment to the single wafer stage.

12. The exposure scanner system as claimed in claim 11, wherein the alignment mark sensors are disposed according to positions of the alignment marks on the wafer.

13. The exposure scanner system as claimed in claim 11, wherein the exposure apparatus and the optical sensor apparatus have the same scan path.

14. The exposure scanner system as claimed in claim 13, wherein the exposure apparatus and the optical sensor apparatus are performed simultaneously along the same scan path.

15. The exposure scanner system as claimed in claim 11, wherein the exposure apparatus and the optical sensor apparatus are performed at the single wafer stage.

16. The exposure scanner system as claimed in claim 11, wherein the alignment mark sensors of the optical sensor apparatus are disposed on two opposite sides of the exposure apparatus.

17. The exposure scanner system as claimed in claim 11, wherein the single wafer stage has a movement path opposite to a scan path of the exposure apparatus.
